(19) United States
(12) Patent Application Publication
(10) Pub. No.: US 2014/0054390 A1
(43) Pub. Date: Feb. 27, 2014

(54) Tubular Service Device

(71) Applicant: Richard Timothy Oliver, Lafayette, LA (US)

(72) Inventor: Richard Timothy Oliver, Lafayette, LA (US)

(21) Appl. No.: 13/971,538

(22) Filed: Aug. 20, 2013

Related U.S. Application Data
(60) Provisional application No. 61/691,856, filed on Aug. 22, 2012.

(51) Int. Cl. B05B 15/06

(52) U.S. Cl. CPC B05B 15/061
USPC 239/1; 239/754

(57) ABSTRACT

A tubular service device, for cleaning, sandblasting, painting, etc. the exterior surface of a tubular. A hoop is positioned on a tubular string by a plurality of rollers, and holds a plurality of nozzles at a desired distance from the tubular surface. A pressurized fluid, such as a cleaning fluid, is pumped through the nozzles onto the tubular surface, at high pressures if required. The device is moved along the length of the tubular by powered rollers or a cable hoist. The tubular service device can also be used to paint or sandblast the tubular surface. A hood or enclosure may be added around the device to capture liquids and solids. The apparatus may be operated remotely, permitting personnel to remain in a secure location while elevated locations are cleaned.

### CROSS REFERENCE TO RELATED APPLICATIONS

This regular patent application claims priority to U.S. provisional patent application Ser. No. 61/691856, filed Aug. 22, 2012, for all purposes.

### BACKGROUND-FIELD OF THE INVENTION

This invention relates to apparatus used in connection with conducting various operations on the exterior surfaces of tubulars, whether positioned horizontally (e.g., pipelines, handrails, etc.), vertically (e.g., tubular risers in offshore oil and gas production facilities) or other orientations.

Two exemplary operations include (1) cleaning the outside of such tubulars, and (2) performing maintenance, such as sandblasting, painting, etc. of the tubulars. As is well known, the tubulars often get dirty due to leaks of oil and other liquids, accumulations of dirt, etc., and from time to time must be cleaned of such substances. Also, since corrosion must be minimized, the tubulars are usually painted, and the painting or other protective coating must be re-done (in whole or part) on a regular basis, at times requiring sandblasting to be done first. In short, periodic work must be done on the tubular outer surfaces.

Several problems arise in connection with such work. A key problem is that the surfaces to be worked on are frequently not readily accessible to a worker standing on a secure work platform—the tubulars may extend vertically a substantial distance, e.g. 50 feet or more, or a horizontal tubular may span a distance between two points, many feet above the surface of the water, the ground, etc. Prior art solutions have included the use of scaffolding, hoists with work baskets, etc. to enable elevating workers to the required elevation in order to do the work. It is readily appreciated that cost and personnel safety issues arise in connection with such procedures. It is desired to have an apparatus which enables service work, including but not limited to cleaning, painting and other procedures on the exterior surfaces of tubulars, which does not require the placement of personnel in close proximity to the surface being worked on.

### SUMMARY OF THE INVENTION

An apparatus embodying the principles of the present invention comprises a hoop structure which at least partially encircles a tubular to be serviced, such as to be cleaned or sandblasted, or painted. The hoop may be of multiple sections to permit disassembly to fit around the tubular, and assembly to at least partially encircle the tubular. A plurality of service nozzles are mounted on the hoop and positioned to deliver a fluid stream onto the outer surface of the tubular. Depending upon the nature of the fluid stream, different means are used to pump the fluid to the nozzles. The hoop and nozzles are held in a desired position with respect to the outer surface of the tubular by a positioning means, which may comprise a plurality of rollers which engage the tubular. Various means may be used to move the service device along the length of the tubular. The apparatus permits cleaning or other servicing of a tubular at an elevated or otherwise relatively inaccessible location, while personnel remain in a secure location.

### BRIEF DESCRIPTION OF THE DRAWINGS

FIG. 1 is a perspective view of an embodiment of the tubular service device embodying the principles of the present invention.

FIG. 2 is a view of an embodiment of the tubular service device of the present invention, mounted on a tubular, with the tubular in cross section, looking down the central axis of the cleaning ring or hoop.

FIG. 3 is a side view of the tubular service device mounted on a tubular, generally showing a horizontal tubular application.

FIG. 4 is another side view of the tubular service device mounted on a tubular, generally showing a vertical tubular application.

FIG. 5 is a view of an exemplary arrangement for use of the tubular service device on a vertical tubular member.

FIG. 6 shows one possible embodiment of an enclosure or shroud around the service device, to capture cleaning fluids and/or materials removed from the surface of the tubular.

### DESCRIPTION OF THE PRESENTLY PREFERRED EMBODIMENT(S)

While a number of embodiments are possible within the scope of the invention, with reference to the drawings some of the presently preferred embodiments can be described.

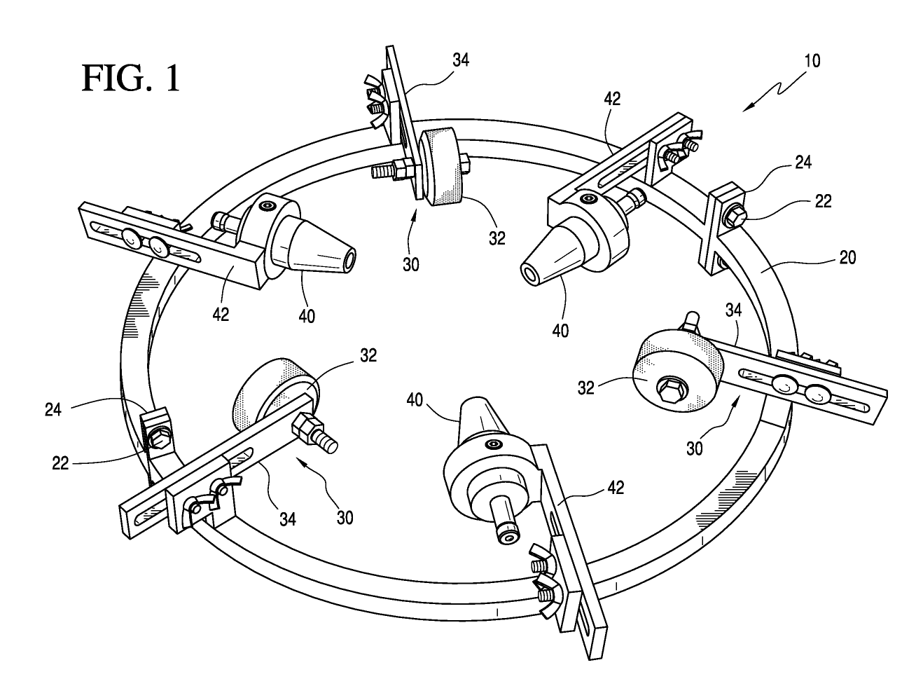

Tubular service device 10 comprises a hoop 20 which at least partially encircles a tubular 50. While the embodiment shown completely encircles tubular 50, it is understood that the scope of the invention encompasses a tubular service device having a hoop 20 which covers (for example) only ¾ of the circumference of the tubular—i.e. is open over a portion of its circumference. Such an embodiment may be useful in situations requiring that tubular service device 10 pass over an obstacle, such as a valve, second tubular joining the one being cleaned, etc. Hoop 20 may be made in two or more segments, so that it may be disassembled and re-assembled about tubular 50 and the pieces joined together, for example via bolts 22 through plates 24 or similar means, as can be seen in FIG. 1.

Hoop 20 is held in a substantially concentric position around tubular 50 by a plurality of means for positioning hoop 20 (and nozzles 40, as later described) with respect to the outer surface of tubular 50, which may comprise roller guide assemblies 30. Roller guide assemblies 30 comprise rollers 32, preferably mounted on an adjustment means, namely an adjustable base 34. Via adjustable base 34, the position of rollers 32 can be moved radially inwardly or outwardly, to accommodate different diameters of tubulars. It is understand that the adjustable bases 34 can incorporate a simple thumbscrew/slot arrangement, as seen in the drawings, or can comprise various forms of powered systems. Further, at least some of the positioning means may comprise simple spring-loaded arms which bear against the tubular.

The invention also encompasses positioning means in which rollers 32 are driven (that is, rotated) by hydraulic or similar means, so as to move tubular service device 10 along the tubular in a remote application.

Tubular service device 10 further comprises service nozzles 40 mounted on hoop 20, by adjustable bases 42, which may be similar to the adjustable bases described above in connection with the roller assemblies. It is to be understood that service nozzles 40 may encompass any one of suitable nozzles to direct any desired fluid onto tubular 50. For example, service nozzles may serve to direct:

1. cleaning solutions, to clean the exterior of the tubular;

2. paint or similar substances, to apply a protective coating to the exterior of the tubular;

3. solids or abrasives of the sort used in sandblasting operations, to remove corrosion, old paint, etc. in preparation for painting or other procedures.

Other applications are possible within the scope of the present invention.

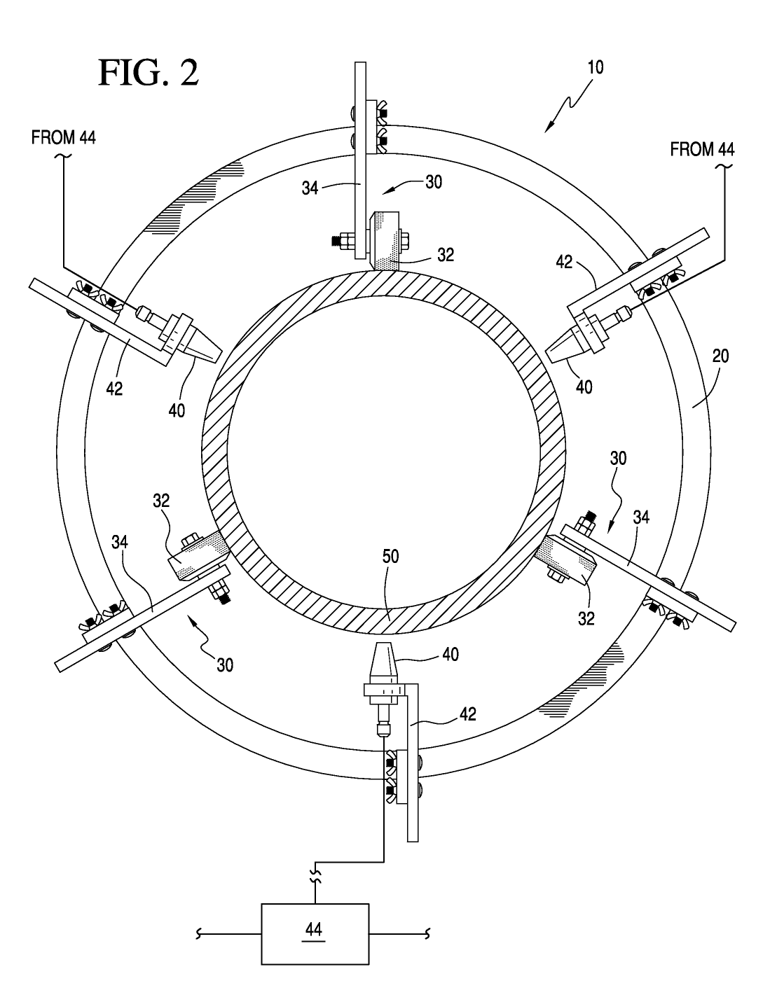

Typically, fluids, which may be highly pressurized fluids, are supplied to service nozzles 40 by a means for pumping fluid to nozzles 40, such as pressurized fluid source 44, for example a pump, along with suitable hoses, piping, etc. as can be seen in FIG. 2. Typically, the pumps would remain in a single location, while tubular service device 10 is moved along the tubular being addressed, at least within the length of the hoses, etc. being used. Tubular service device 10 may be used for a variety of purposes, including painting, cleaning, etc. When the apparatus is used for painting, relatively low pressures are involved, sufficient to deliver the paint to the apparatus and spray it onto the tubular surface. However, when the apparatus is used for cleaning of the tubular surface, typically relatively high pressures are required. It is believed that pressures in the 1000s of pounds per square inch (PSI) are best used, for example 5,000 PSI, 10,000 PSI, or even higher pressures, up to 50,000 to 60,000 PSI. It is understood that the scope of the invention is not limited to any particular fluid being pumped, nor to any pump pressure for the fluid, but encompasses all fluids, solids (e.g. for sandblasting) delivery rates/pressures, etc.

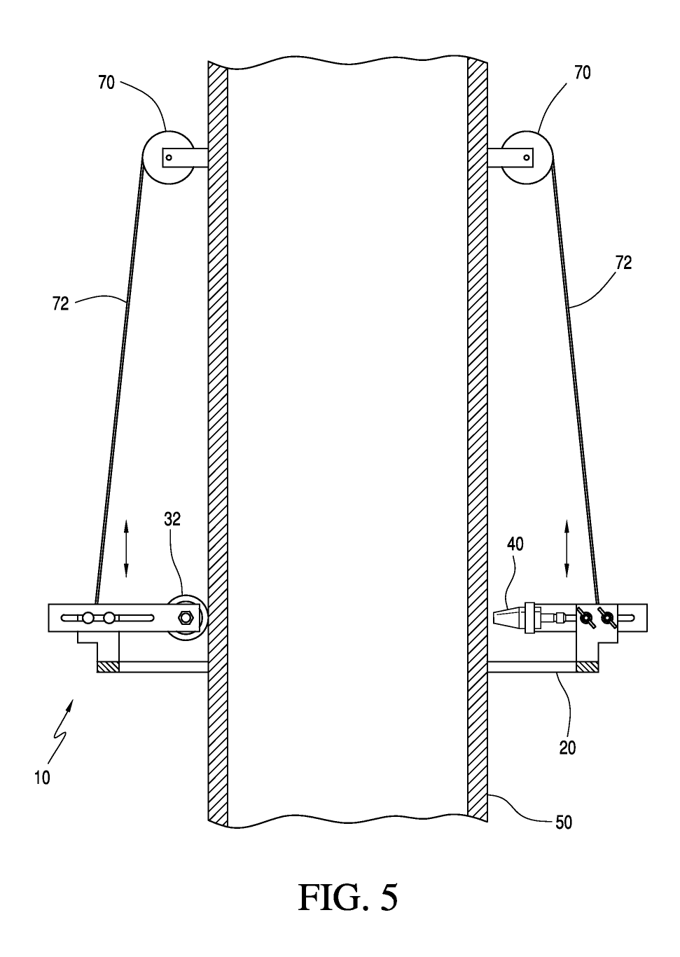

It is understood that tubular service device 10 must generally be moved along the length of a tubular in order to carry out the desired task. A variety of means for moving tubular service device 10 along a length of tubular 50 may be used to effect this movement. One possible means, as mentioned above, is via powered rollers 32, rotated by hydraulic, pneumatic or other suitable means. Certain applications may use a hoist type apparatus to raise and lower tubular service device 10, as shown in FIG. 5. Powered hoist means 70 are connected to tubular service device 10 by cables 72, which enable raising/lowering of the device as needed. It is understood that a powered hoist means 70 and cables 72 could also be employed to move tubular service device 10 along a horizontal tubular.

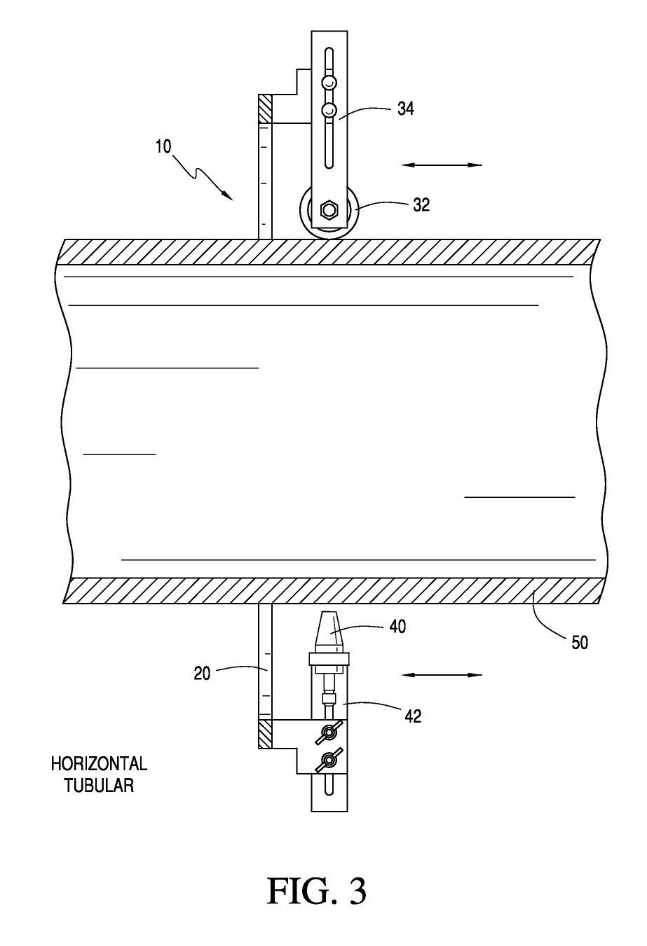

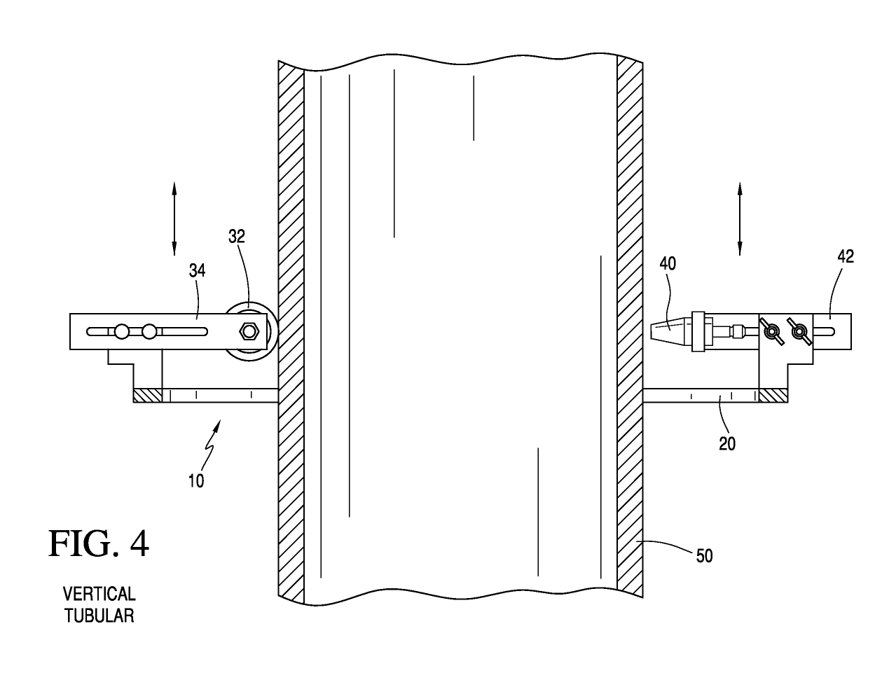

FIG. 3 shows an application of tubular service device 10 on a horizontal tubular, a cross section of tubular service device 10 and tubular 50 being shown. As noted above, tubular service device 10 may be moved along the length of tubular 50 by powered rollers 32, or a cable and hoist means. FIG. 4 shows an example of use of the tubular service device on a vertical tubular.

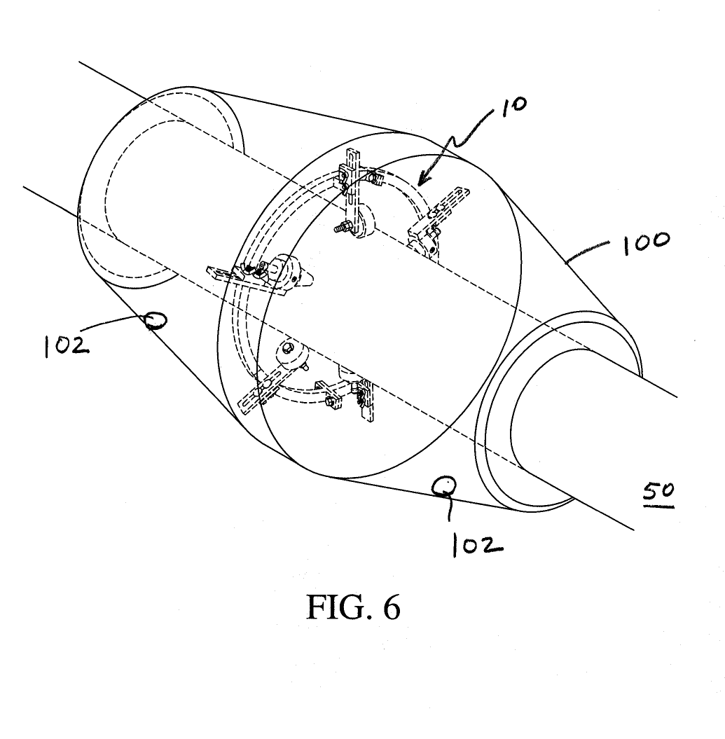

Various applications may require that the fluids/solids being directed onto the tubular surface, and/or the materials thus removed from the tubular surface, be captured. For example, it can be readily understood that paint particles would drift onto surrounding surfaces, or the water; cleaning fluids escape to the environment; likewise sandblasting sand and the paint or other particles blasted off must be captured. This need is satisfied by partially or fully enclosing the tubular service device 10 in a shroud or hood. While various configurations are possible and contemplated within the scope of the invention, FIG. 6 sets out one possible embodiment of a containment hood 100. Certain element numbers are omitted from FIG. 6 for clarity. Hood 100 may be made from a fabric material over a rigid framework, or may be made from a rigid material such as thin metal, e.g. aluminum; or fiberglass, or some combination of the two. As can be readily understood from the drawings, hood 100 is of a configuration that it can be opened, put in place around the service device 10, then closed. Openings 102 permit passage of hoses, etc. carrying the fluid being pumped. Openings 102 are also provided to permit connection of hoses carrying off the liquid/solids which are captured within hood 100.

### Fabrication, Materials for the Tubular Service Device

Fabrication of the tubular service device 10 may be done by forming, welding, bolted connections, etc. well known in the relevant art. Materials may include high strength metals, with non-metallic materials and components, e.g. fiberglass, composites, etc., used where applicable.

### Applications for the Tubular Service Device

The scope of the present invention encompasses use of the tubular service device on any sort of elongated, generally tubular members, such as vertical risers or tubulars in oil and gas production/processing facilities; horizontal and vertical tubular members in all settings, including handrails; pipelines; wind turbine pylons and blades; piping in refineries and plant environments, etc. It is to be understood that the term “tubular” as used herein encompasses structural members of all shapes of elongated members, whether circular in cross section or not, including (as referenced above) members such as wind turbine blades.

A key aspect of the invention is the servicing, whether cleaning, painting, etc. of tubulars at elevated or other positions, in which it would be difficult and/or hazardous to have personnel physically in close proximity to the apparatus or the section of the tubular being cleaning. The means for moving the apparatus along the tubular permits remote operation thereof, with personnel in a secure location.

### Conclusion

While the preceding description contains many specificities, it is to be understood that same are presented only to describe some of the presently preferred embodiments of the invention, and not by way of limitation. Changes can be made to various aspects of the invention, without departing from the scope thereof. For example, dimensions of the device may be changed to meet different applications; pressures at which service fluids are supplied may be changed to suit the type of tubular being serviced; virtually any orientation of tubular may be serviced, etc.

Therefore, the scope of the invention is to be determined not by the illustrative examples set forth above, but by the appended claims and their legal equivalents.

I claim:

1. A tubular service device for servicing an outer surface of a tubular, comprising:
a hoop sized and configured to extend at least partially around a circumference of said tubular;
one or more fluid nozzles fixed to said hoop and directed inwardly toward said outer surface of said tubular, so that fluids pumped through said nozzles contacts said outer surface of said tubular;
a means for pumping fluid to said nozzles;
a means for positioning said hoop and said nozzles with respect to said outer surface of said tubular; and
a means for moving said hoop along a length of said tubular.

2. The tubular service device of claim 1, wherein said means for moving said hoop comprises a plurality of cables attached to said hoop and connected to a powered hoist.

3. The tubular service device of claim 1, wherein said hoop comprises multiple segments adapted to be disassembled and reassembled around said tubular.

4. The tubular service device of claim 1, wherein said means for positioning comprises a plurality of rollers connected to said hoop and engaging said outer surface of said tubular.

5. The tubular service device of claim 1, wherein said nozzles are attached to said hoop by an adjustment means, whereby a distance from the discharge of said nozzles to said outer surface of said tubular is adjustable.

6. The tubular service device of claim 1, further comprising a hood enclosing said hoop and said nozzles, wherein fluids and solids generated in the servicing of said tubular are captured within said hood.

7. The tubular service device of claim 3, wherein said means for positioning comprises a plurality of rollers connected to said hoop and engaging said outer surface of said tubular, and wherein said nozzles are attached to said hoop by an adjustment means, whereby a distance from the discharge of said nozzles to said outer surface of said tubular is adjustable.

8. An apparatus for servicing an exterior surface of a tubular, comprising:
a hoop sized and configured to extend at least partially around a circumference of said tubular, said hoop comprising multiple segments adapted to be disassembled and reassembled around said tubular;
one or more fluid nozzles fixed to said hoop and directed inwardly toward said outer surface of said tubular, so that fluids pumped through said nozzles contacts said outer surface of said tubular, wherein said nozzles are fixed to said hoop by a means permitting adjustment of a distance from the discharge of said nozzles to said outer surface of said tubular;
a means for pumping fluid to said nozzles;
a plurality of rollers connected to said hoop and engaging said outer surface of said tubular, said rollers holding said hoop and said nozzles at a desired distance from said outer surface of said tubular; and
a means for moving said hoop along a length of said tubular.

9. A method for remotely directing fluids onto an outer surface of a tubular, comprising:
a. providing an apparatus comprising:
a hoop sized and configured to extend at least partially around a circumference of said tubular;
one or more fluid nozzles fixed to said hoop and directed inwardly toward said outer surface of said tubular, so that fluids pumped through said nozzles contacts said outer surface of said tubular;
a means for pumping fluid to said nozzles; and
a means for positioning said hoop and said nozzles with respect to said outer surface of said tubular;
b. positioning said apparatus on a tubular, and adjusting said nozzles to a desired distance from said outer surface of said tubular;
c. pumping a fluid to said nozzles, whereby said fluid exits said nozzles and contacts said outer surface of said tubular;
d. moving said apparatus along a length of said tubular,
wherein personnel operating said apparatus remain in a secure location while said apparatus services said tubular in an elevated or otherwise inaccessible location.
